(19) United States
(12) Patent Application Publication
(10) Pub. No.: US 2006/0049110 A1
(43) Pub. Date: Mar. 9, 2006

(54) Method and device for killing bacteria, viruses, fungus, parasites and worms in water and food with a rotating magnet

(76) Inventor: Kim Shallcross, Milton (CA)

Correspondence Address: SHUGHART THOMSON & KILROY, PC, 120 WEST 12TH STREET, KANSAS CITY, MO, 64105, US

(21) Appl. No.: 10/521,415

(22) PCT Filed: Jul. 11, 2003
(86) PCT No.: PCT/CA03/00966

§ 371 Date: Aug. 1, 2005

(30) Foreign Application Priority Data
Jul. 12, 2002 (CA) 2,393,169

(51) Int. Cl. C02F 1/48

(52) U.S. Cl. 210/695; 210/222

(57) ABSTRACT

A device and method for purifying water and other substrates from pathogens selected from the group consisting of bacteria, viruses, fungi, parasites, and worms, comprises at least one magnet mounted in rows on the faces of a block (1) for rotation on a shaft (2) and means (3) to rotate the shaft.

### FIELD OF THE INVENTION

The present invention relates to the field of purification of water and other substrates. The present invention provides a method and apparatus for the purification of water and other substrates.

The present invention provides an apparatus to treat water, and other substrates, using a rotating series of magnets to kill bacteria and virus and the like in the water.

### BACKGROUND OF THE INVENTION

It is known to use a rotating magnet to “magnetize” water, for instance using a Watermag™. That product uses a rotating magnetic field to treat water to reduce scale, lower water viscosity, increase calcium solubility, and promote health.

Devices for magnetically treating water are also shown in U.S. Pat. No. 5,816,058 (Lee et al.) and U.S. Pat. No. 6,171,490 (Kim et al.). The Kim patent discloses a device configured like a blender with a bar magnet attached to the shaft of the blender motor. This unit provides minimal magnetic effect, and is not suitable for bulk water treatment. It does not, moreover, purport to eliminate viruses and bacteria by magnetic treatment.

The Lee et al. device for Magnetically Treating Water has a magnet, and rotates water around it. It will be understood that this unit provides magnetic treatment, by exposing water to magnets spinning on the axial face of a shaft. It does not purport to purify the water being treated of virus and bacteria.

The present invention utilizes magnets to treat water differently from known magnetic water treatments, by utilizing a series of magnets, mounted radially on a rotating shaft. In a preferred embodiment, the magnets are mounted on the shaft with their polar face radially outward relative to the axis of the shaft. In a more preferred embodiment, the shaft has a plurality, eg. six (but other numbers are possible) of faces with a row of similarly oriented magnets on each face. Most preferably, the magnets are neodymium-boron-iron magnets, mounted in linear rows on a shaft of an electric motor.

In a broad aspect, then, the present invention relates to a device for purifying water and other substrates from pathogens selected from the group consisting of bacteria, viruses, fungi, parasites, and worms, comprising: at least one magnet mounted for rotation on a shaft; and means to rotate said shaft.

In drawings that illustrate the present invention by way of example:

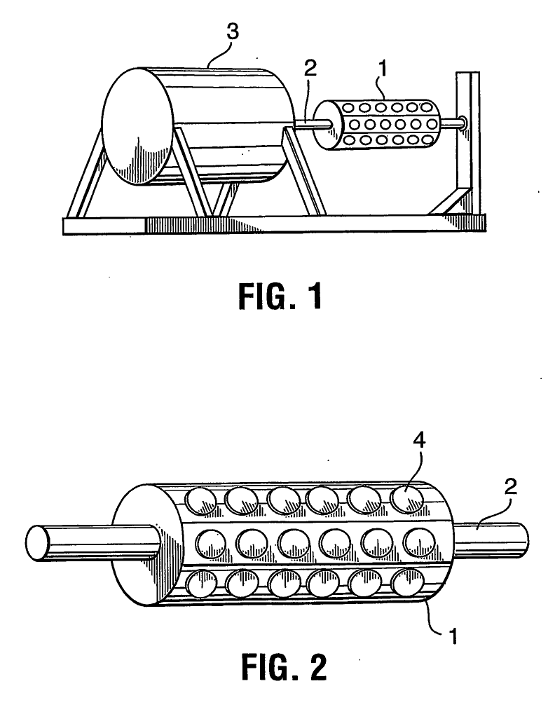

FIG. 1 is a schematic of an apparatus of a preferred embodiment of the present invention;

FIG. 2 is a detail view of the magnet holding shaft of the apparatus of FIG. 1.

Referring now to the drawings, the apparatus of the present invention a block 1 mounted coaxially on a shaft 2 coupled to an electric motor 3. It will be understood that electric motor 3 may be any other means to rotate the shaft 2, such as a hydraulic motor, as will be obvious to one skilled in the art. Moreover, shaft 2 may be rotated by hand, if desired.

Magnets 4, which are preferably neodymium magnets such as NE027 0.750 (dia)×0.500 (ht) 27 MGOe magnets, from Jobmaster Magnets, Inc. of Mississauga, Ontario, are mounted in rows on the faces of block 1. There may be from 2 to about 12 (or more) faces on block 1 which may be made from any material, such as aluminum. A practical number of faces is 6. The number of magnets in each row is any number from 1 to 20 or more, depending on the size of installation. A practical number is 6. The magnets in each face are preferably mounted with similar polarity, for maximum effect, but the invention will function regardless of the orientation of the individual magnets. For maximum effect, three rows of magnets on one side of a six sided block 1 will have similar orientation, and the three rows on the opposite side will have opposite orientation.

A second preferred arrangement is a six sided block, with from magnets of alternating polarity on each side or facet. This will create a checkerboard effect. It will be understood, moreover, that the magnets may be round, square, or any other desired shape. They may be permanent magnets or in a manner obvious to one skilled in the art, electromagnets.

The block is rotated by the motor at any speed, and it has been found that a rotational speed of about 1150 rpm will be effective.

Water, or other substrate, to be purified is passed close to the rotating magnet block 1, and it has been found that viruses and bacteria in the water or other substrate is eliminated. The substrate may be brought into proximity with the rotating magnetic field of the block in batches, eg. a litre or two at a time, or it may be flowed by in a pipe. It is necessary only that the substrate enter the rotating magnetic field. Residence time in the field is not required. Tests were conducted with the apparatus illustrated and described, as follows:

### EXAMPLE 1

Three samples of water containing:
1) E. coli (Generic) bacteria;
2) E. coli (MS2) bacteria;
3) Pseudomonas aeruginosa bacteria

were measured for bacterial concentration, 5 ml samples of each were then brought into proximity (about 10 cm) with the rotating block (1150 rpm) apparatus described above. Results of bacterial concentration readings after treatment were as follows:

TABLE 1

| | Initial Concentration | Final Concentration |
|---|---|---|
| Sample No. | cfu/ml | cfu/ml |
| 1 | 0.15 | 0.06 |
| 2 | 7.0 × 10² | 2.6 |
| 3 | 1.9 | 0.3 |

It will be observed, then, that treatment with the device of the present invention provides up to over 99% reduction of harmful bacteria. Moreover, it has been determined that the time needed for the bactericiodal effect is only about 0.03 seconds.

The present invention has uses other than those discussed herein with relation to water purification. The present invention will destroy pathogens, including bacteria, viruses, worms, fungus and flagellants. The present invention will also kill the virus responsible for mad cow disease, a condition heretofore believed to be caused by prions.

The present invention will also break down toxic chemicals into elemental parts. For instance, carbon monoxide in car exhaust when treated with the present invention will break down to carbon and ionized oxygen. Methyl mercury exposed to the present invention will break down to a mercury salt. The present invention will transform free radicals into stable elements.

The present invention will stabilize radioactive matter, including radioactive waste toxins, rendering it less harmful.

The present invention can also be used to sterilize surgical instruments more thoroughly than an autoclave.

Moreover, water treated by exposure to the present invention for a longer duration, eg. 11 hours, has a curative effect. When drunk over a period of time, it will cure persistent internal infections such as streptococcus, staphylococcus, clostridium, dental infections, and “super bugs”, i.e. antibiotic-resistant bacteria.

It will be appreciated that numerous modifications and alterations of the present invention will be possible without departing from the spirit of the invention.

1-11. (canceled)

12. A device for purifying water and other substrates from pathogens selected from the group consisting of bacteria, viruses, fungi, parasites, and worms, comprising:
at least one magnet mounted for rotation on a shaft; and
means to rotate said shaft.

13. A device as claimed in claim 12 wherein said magnets are radially oriented relative to the axis of rotation of said shaft.

14. A device as claimed in claim 13 wherein said magnets are mounted in a block mounted on said shaft co-axially therewith.

15. A device as claimed in claim 14 wherein said magnets are mounted in rows on axial facets of said block.

16. A device as claimed in claim 15 including six said facets.

17. A device as claimed in claim 15 wherein the magnets in each row are similarly north/south oriented.

18. A device as claimed in claim 12 wherein said magnets are neodymium magnets.

19. A device as claimed in claim 12 wherein said magnets are neodymium-boron-iron magnets.

20. A device as claimed in claim 12 wherein said magnets are electromagnets.

21. A device for purifying water and other substrates from pathogens selected from the group consisting of bacteria, viruses, fungi, parasites, and worms, comprising:
a plurality of magnets are mounted for rotation on a shaft; and
means to rotate said shaft.

22. A device as claimed in claim 21 wherein said magnets are radially oriented relative to the axis of rotation of said shaft.

23. A device as claimed in claim 22 wherein said magnets are mounted in a block mounted on said shaft co-axially therewith.

24. A device as claimed in claim 23 wherein said magnets are mounted in rows on axial facets of said block.

25. A device as claimed in claim 24 including six said facets.

26. A device as claimed in claim 24 wherein the magnets in each row are similarly north/south oriented.

27. A device as claimed in claim 26 including six said facets.

28. A device as claimed in claim 21 wherein said magnets are neodymium magnets.

29. A device as claimed in claim 21 wherein said magnets are neodymium-boron-iron magnets.

30. A device as claimed in claim 21 wherein said magnets are electromagnets.

31. A method of purifying water or any other substrate comprising:
providing a device comprising;
at least one magnet mounted for rotation on a shaft,
means to rotate said shaft,
rotating said shaft, and
bringing water or other substrate into proximity with said at least one magnet.
